(19) United States
(12) Patent Application Publication
(10) Pub. No.: US 2009/0110300 A1
(43) Pub. Date: Apr. 30, 2009

(54) APPARATUS AND METHOD FOR PROCESSING IMAGE

(76) Inventors: Yuka Kihara, Kanagawa (JP); Koji Kobayashi, Kanagawa (JP); Hirohisa Inamoto, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/243,296

(22) Filed: Oct. 1, 2008

(30) Foreign Application Priority Data
Oct. 31, 2007 (JP) 2007-283040

(51) Int. Cl. G06K 9/62

(52) U.S. Cl. 382/224

(57) ABSTRACT

A classifying unit classifies a plurality of images by attributes. An obtaining unit obtains image characteristic information indicating an image characteristic from each of classified images. A first generating unit generates a characteristic amount vector for each of the images using the attributes and the image characteristic. A determining unit determines display positions of thumbnail images of the images based on the characteristic amount vector. A second generating unit generates the thumbnail images and a list of thumbnail images in which the thumbnail images are arranged in the display positions.

### CROSS-REFERENCE TO RELATED APPLICATIONS

The present application claims priority to and incorporates by reference the entire contents of Japanese priority document 2007-283040 filed in Japan on Oct. 31, 2007.

### BACKGROUND OF THE INVENTION

1. Field of the Invention

The present invention relates to an apparatus and a method for displaying thumbnail images on a display device to allow a user to retrieve a desired image from images stored in a storing device.

2. Description of the Related Art

When a user retrieves a desired image from a large number of images stored in a storing device, the user needs to check a large number of images. A thumbnail image display in which minified images are displayed is conventionally known as a way to allow the user to easily check the large number of images. A thumbnail image of a still image refers to an image having a reduced image size achieved by a pixel skipping. The user can check a plurality of images at once by a list of thumbnail images displayed on a screen. Therefore, the user can efficiently retrieve the desired image from a large number of images.

Technologies are known in which various modifications are made in a display method to allow the user to easily recognize contents of the thumbnail images on the thumbnail image display (see, for example, Japanese Patent Application Laid-open No. 2001-337994 and Japanese Patent Application Laid-open No. 2006-277409). For example, in a technology described in Japanese Patent Application Laid-open No. 2001-337994, additional information related to an original image is associated with a thumbnail image and registered. The additional information includes file name, date of creation, date of update, and security level. During thumbnail image display, the additional information is retrieved and displayed with the thumbnail image in an overlapping manner or the like. In a technology described in Japanese Patent Application Laid-open No. 2006-277409, object display mode is provided as a thumbnail display mode. In object display mode, a certain object is specified, such as “people” or “license plate”. A partial image is displayed as a thumbnail image. As a result, work and time required of the user can be reduced primarily when the user is searching for an object appearing in a photographic image.

When image retrieval is performed by thumbnail image display in a manner such as those described above, the user often uses a search query through which the user can specify a feature of an image and make a query. In this case, a display method is preferably used that allows the user to not only easily recognize the contents of the thumbnail images, but also easily recognize an association between displayed thumbnail images.

Therefore, there is a technology that improves retrieval efficiency by mapping the thumbnail images based on image characteristics (hereinafter, “an image map”). An advantage of the thumbnail images being displayed using the image map is that the user themselves can more easily visually identify a required thumbnail image because a group of thumbnail images with similar properties are arranged together on a screen. Methods of mapping the thumbnail images are described in Japanese Patent Publication No. 3614235, Japanese Patent Application Laid-open No. 2005-55743, and Japanese Patent Application Laid-open No. 2005-235041. In a method described in Japanese Patent Publication No. 3614235, for example, feature quantities are extracted from each image to be displayed, and characteristic amount vectors are formed. The feature quantities include color, shape, size, type, a purpose keyword, and the like. A characteristic amount vector is projected onto a two-dimensional coordinate axis through use of a self-organizing map (SOM) and the like. Moreover, perspective is moved three-dimensionally by information density being modified and a plurality of screens being aligned in a depth direction. As a result, retrieval of a desired image is facilitated.

In a method described in Japanese Patent Application Laid-open No. 2005-55743, an image attribute of each image to be displayed is obtained. A center point is set on a screen for each attribute value. Subsequently, the attribute is obtained from each image to be displayed, and a thumbnail image of each image to be displayed is disposed near a center point related to the attribute value. As a result, thumbnail images of images having a same attribute value are displayed together. In a method described in Japanese Patent Application Laid-open No. 2005-235041, an n-dimensional characteristic amount is extracted from data of each image. A new two-dimensional characteristic amount is calculated by a multivariate statistical analysis process. Furthermore, a display position and a display size are determined based on clustering information.

It is important that the above image map provides a system allowing a user to easily and accurately recognize an area of interest. Therefore, the thumbnail images in the image map are preferably displayed clustered by attribute values.

On the other hand, when retrieval is performed through use of the above image map, a suitable browsing method can be considered as follows. The user specifies an area of interest from an arrangement on the image map. The user can visually narrow down an image to be retrieved by repeatedly zooming in on an area centering on the area of interest. In an image map-type retrieval system including a browsing function such as that described above, a retrieval state in which the image is retrieved is switched in stages as a result of the user repeatedly performing a zoom-in operation. An image map used in an image map-type retrieval system such as that described above should be created taking in to consideration the retrieval state (retrieval stage) that is switched in stages, in addition to transition of the screen. In other words, as described above, the images are required to be displayed in clusters based on a certain rule to narrow down the image to be retrieved on an initial screen of the image map. However, in addition, a structure is required that allows the user to recognize a subsequent area of interest without confusion each time the user performs the zoom-in operation.

In the image map type retrieval system, the retrieval stage at which the user performs retrieval can be largely divided into two stages. At the first stage, the user narrows down an area of interest. When a large number of thumbnail images are on the initial screen, the user does not compare each image. Instead, the user views the image map to determine approximately where a target image is present. The user repeatedly performs an operation for zooming in on the area of interest and further narrowing down the area of interest. After the first stage of narrowing down the area of interest, when the number of thumbnail images in the area of interest is less than a certain number of thumbnail images, the user proceeds to the second stage of retrieval at which the user compares each image and retrieves the target image.

However, in the methods described in Japanese Patent Publication No. 3614235, Japanese Patent Application Laid-open No. 2005-55743, and Japanese Patent Application Laid-open No. 2005-235041, no consideration is given to usability as a retrieval system providing browsing function. Therefore, even when the methods are effective for the initial screen, it is difficult for the user to narrow down the area of interest in stages. It is highly possible that the user will lose sight of the target image.

For example, in the method described in Japanese Patent Publication No. 3614235, thumbnail image display is performed by clustering based on a degree of similarity between characteristic amount vectors, through use of the SOM and the like. However, in the method, classification of an obtained cluster cannot be specified in advance. Therefore, clusters cannot be classified and displayed in a manner allowing the user to easily retrieve an image. However, it is required that the user can easily visually recognize a classification concept of each cluster to allow the user to narrow down the area of interest on a mapped thumbnail list display screen. Therefore, each cluster is preferably classified using easily visually recognizable characteristics, such as overall color and configuration.

In the method described in Japanese Patent Application Laid-open No. 2005-55743, a classification title and the like are set in advance as a class. Each thumbnail image is then arranged near a class to which the image belongs. In the method, the classification concept of each class is easily communicated to the user. However, a center coordinate of each class is required to be set in advance. Moreover, because no rules are given regarding arrangement of the images within each class, even when the user can narrow down the area of interest during browsing, it becomes difficult for the user to find the target image within the area of interest when a large number of images are present in the area of interest.

In the method described in Japanese Patent Application Laid-open No. 2005-235041, a new two-dimensional characteristic amount is calculated from a image characteristic amount by a principal component analysis process. Each image is considered to be a point in a metric space with the two-dimensional characteristic amount serving as two axes. As a result, the images can be displayed clustered into a certain number of cluster groups. However, even though the number of clusters can be specified in advance, the classification concept of each cluster cannot be specified in advance. Therefore, the classification concept of each cluster may not be clear to the user.

### SUMMARY OF THE INVENTION

It is an object of the present invention to at least partially solve the problems in the conventional technology.

According to one aspect of the present invention, there is provided an apparatus for processing an image. The apparatus includes a classifying unit that analyzes a plurality of images to be displayed and classifies the images by attributes; an obtaining unit that obtains image characteristic information indicating an image characteristic from each of classified images; a first generating unit that generates a characteristic amount vector for each of the images using the attributes and the image characteristic; a determining unit that determines display positions of thumbnail images of the images such that thumbnail images of same attribute are displayed close to each other and thumbnail images of higher degree of similarity are displayed closer to each other based on the characteristic amount vector generated by the first generating unit; and a second generating unit that generates the thumbnail images and a list of thumbnail images in which the thumbnail images are arranged in the display positions determined by the determining unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an example of a configuration of an image processing apparatus according to a first embodiment of the present invention;

FIG. 2 is a schematic diagram of an example of attributes identified by an attribute identifying unit according to the first embodiment;

FIG. 3 is a flowchart of a process for displaying a list of thumbnail images performed by the image processing apparatus according to the first embodiment;

FIG. 4 is a schematic diagram of an example of characteristic amount vectors according to the first embodiment;

FIG. 5 is a schematic diagram of an example of the list of thumbnail images when an ordinary document image is to be displayed;

FIG. 6 is a schematic diagram of an example in which attributes of a photographic image are set up to the second level according to a second embodiment of the present invention;

FIG. 7 is a flowchart of a process for displaying thumbnail images performed by an image processing apparatus according to the second embodiment;

FIG. 8 is a schematic diagram of an example of characteristic amount vectors according to the second embodiment;

FIG. 9 is a schematic diagram of an example of characteristic amount vectors according to the second embodiment;

FIG. 10 is a conceptual diagram of when a list of thumbnail images of images set to an attribute classification having a hierarchical structure reaching the second level is displayed according to the second embodiment;

FIG. 11 is a schematic diagram of an example of a list of thumbnail images on an initial screen according to the second embodiment;

FIG. 12 is a flowchart of a process for displaying thumbnail images performed by an image processing apparatus according to a third embodiment of the present invention;

FIG. 13 is a flowchart of a process for displaying thumbnail images performed by an image processing apparatus according to a fourth embodiment of the present invention; and

FIG. 14 is a flowchart of a process for displaying thumbnail images performed by an image processing apparatus according to a modification of the fourth embodiment.

### DETAILED DESCRIPTION OF THE PREFERRED EMBODIMENTS

Exemplary embodiments of the present invention are described in detail below with reference to the accompanying drawings.

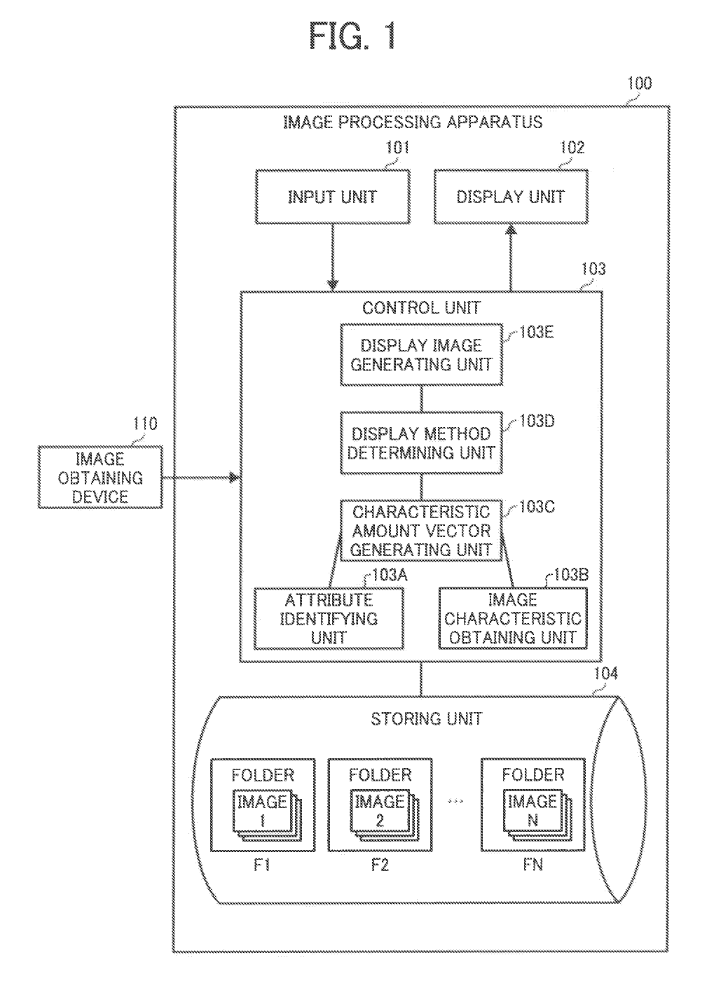

FIG. 1 is a schematic diagram of an example of a configuration of an image processing apparatus 100 according to a first embodiment of the present invention. The image processing apparatus 100 includes an input unit 101, a display unit 102, a control unit 103, and a storing unit 104. The input unit 101 is a keyboard, a pointing device such as a mouse, and the like. The input unit 101 receives instructions regarding search conditions and various instructions regarding additions and changes made to the search conditions entered by a user. The display unit 102 is a liquid crystal display, a cathode ray tube (CRT) display, and the like. The display unit 102 displays a thumbnail image of an image identified from within a group of images based on a search condition, an instruction request or an instruction result from the input unit 101, and the like.

The storing unit 104 is, for example, a hard disk device. The storing unit 104 stores therein images obtained by an image obtaining device 110, images of documents, such as conference material read by a scanner, and the like as data. The image obtaining device 110 is an imaging device, such as a camera. The storing unit 104 respectively stores a thumbnail image of each image and image characteristic information indicating image characteristics of each image in image folder F1 to image folder FN. The image characteristic information includes texture information, color histogram information, and the like as image characteristic quantities. An image characteristic amount is a quantified image characteristic. The texture information is related to a texture of an image. The color histogram information indicates a color scheme of an image.

The control unit 103 is, for example, a central processing unit (CPU), a read-only memory (ROM), and a random access memory (RAM). The image processing apparatus 100 provides various functions by running various programs stored in the ROM. The functions provided by the image processing apparatus 100 include an attribute identifying unit 103A, an image characteristic obtaining unit 103B, a characteristic amount vector generating unit 103C, a display method determining unit 103D, and a display image generating unit 103E, shown in FIG. 1. The attribute identifying unit 103A identifies an attribute of each image by reading an image to be displayed from the storing unit 104 and analyzing the image. The attribute identifying unit 103A then classifies each image by attribute. The attribute identifying unit 103A also associates attribute information indicating the identified attribute with the image and stores the attribute information in the above image folder F1 to image folder FN.

A method described in Japanese Patent Application Laid-open No. 2006-39658, for example, can be used to analyze the image and identify the attribute of the image. In the method, the image is covered by windows. A window refers to a predetermined area that is sufficiently smaller in size than the image. A group of partial images is created. A partial image is a small area of the image cut out from each window. A sequence relationship is established among all cut partial images, the sequence relationship being equivalent to a degree of dissimilarity between the partial images. Based only on the sequence relationship, each partial image is mapped to a point in an arbitrary metric space. Using a Cartesian product or a tensor product of a position coordinate vector of the mapped point in the metric space as the characteristic amount of the image, class classification learning and class identification of the image is performed.

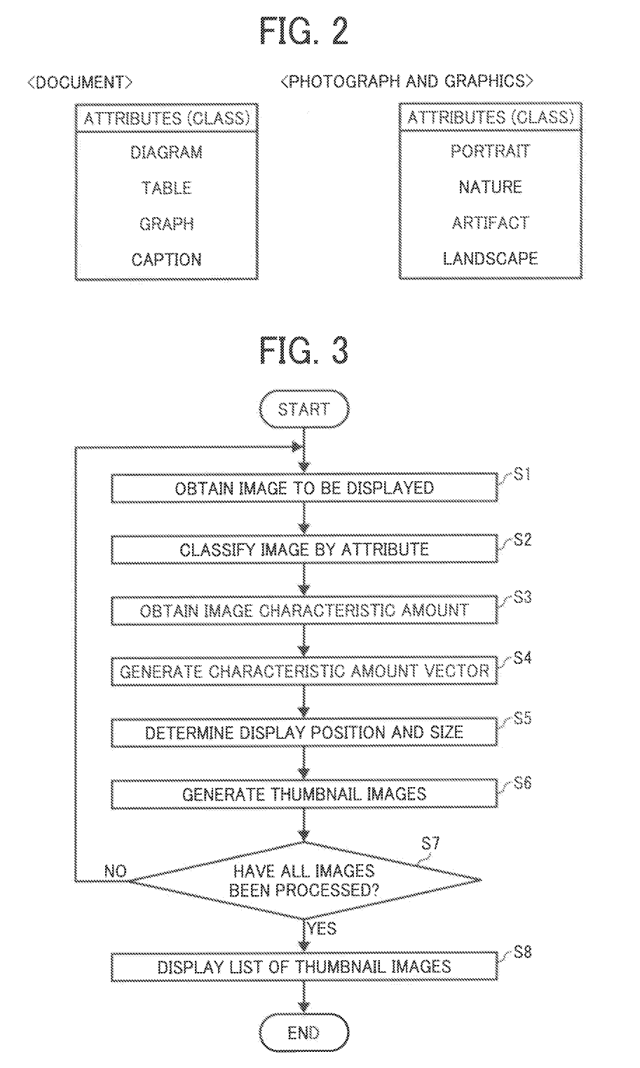

FIG. 2 is a schematic diagram of an example of the attributes identified by the attribute identifying unit 103A. The attributes of an ordinary document image, for example, are diagram, table, graph, and caption. The attributes of a photographic image and a graphic image, for example, are portrait, nature, artifact, and landscape. In this way, an attribute indicating an overview of the image is used.

The image characteristic obtaining unit 103B obtains feature information of each image from the image folder F1 to image folder FN. The characteristic amount vector generating unit 103C generates a characteristic amount vector for each image using the attribute information and image characteristic amount stored in each image folder F1 to image folder FN in the storing unit 104. The display method determining unit 103D determines a display position of the thumbnail image by projecting the characteristic amount vector generated by the characteristic amount vector generating unit 103C onto a viewing plane. The display method determining unit 103D minifies each image to be displayed and generates the thumbnail images. The display image generating unit 103E generates a list of thumbnail images in which each thumbnail image is disposed at the display position determined by the display method determining unit 103D. The display image generating unit 103E then outputs the generated list of thumbnail images to the display unit 102.

A process for displaying the list of thumbnail images performed by the image processing apparatus 100 according to the first embodiment will be described with reference to FIG. 3. The attribute identifying unit 103A of the image processing apparatus 100 reads each image to be displayed from the storing unit 104 (Step S1). The attribute identifying unit 103A then analyzes each image, identifies the attribute of each image, and classifies each image by the attribute (Step S2). In other words, the attribute identifying unit 103A classifies each image into a class based on the attribute. Then, the attribute identifying unit 103A associates the attribute information indicating the identified attribute with the image and stores the attribute information in the above image folder F1 to image folder FN. Next, the image characteristic obtaining unit 103B obtains the image characteristic amount of each image (Step S3). Then, the characteristic amount vector generating unit 103C generates the characteristic amount vector of each image based on the attribute information stored in each image folder F1 to image folder FN and the image characteristic amount obtained at Step S3 (Step S4).

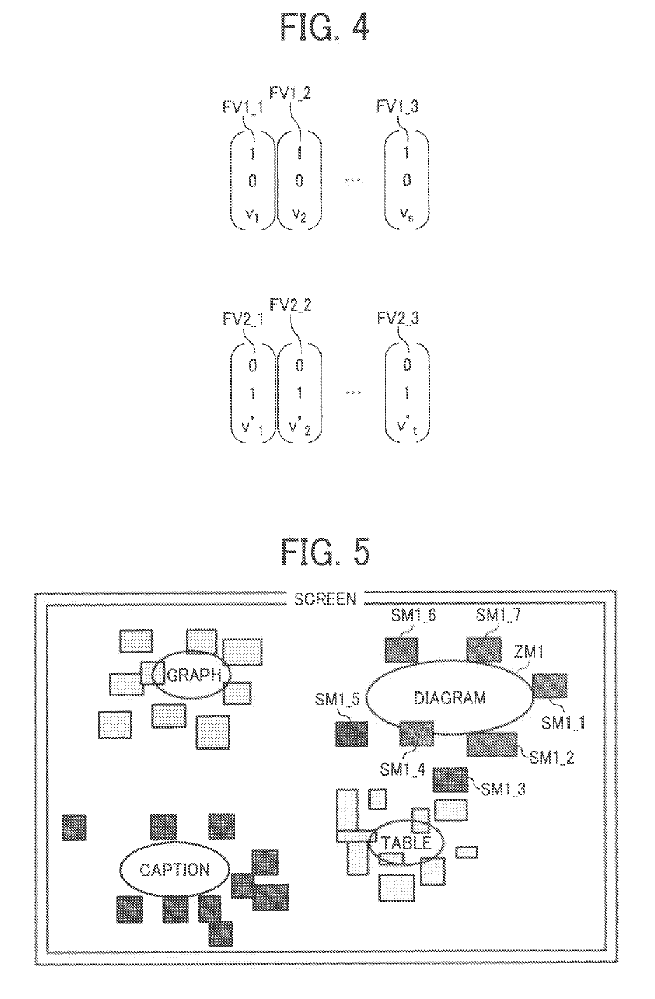

At this time, the characteristic amount vector generating unit 103C generates the characteristic amount vector by combining a quantified and vectored attribute indicated by the attribute information and a vectored image characteristic amount. FIG. 4 is a schematic diagram of an example of characteristic amount vectors. In the characteristic amount vectors in FIG. 4, images belonging to different attributes (classes) are linearly independent. For example, characteristic amount vector FV1_1 to characteristic amount vector FV1_3 indicate characteristic amount vectors generated when the images belong to class 1 (for example, “diagram” in FIG. 2). Characteristic amount vector FV2_1 to characteristic amount vector FV2_3 indicate characteristic amount vectors generated when, for example, the images belong to class 2 (for example, “table” in FIG. 2). In the example, an attribute number, namely a class number, is “2”. The vectored image characteristic quantities are respectively “v1v2 . . . vs” and “v′1v′2 . . . v′t”. Because the class number is “2”, a number of dimensions by which the attribute is quantified here is two-dimension. An “n+2” dimensional characteristic amount vector is generated by the image characteristic amount being combined with the vectored number of dimension “n”. When the characteristic amount vector is configured in this way, generally, when the class number is “m”, the number of dimensions of the characteristic amount vector after composition is “m+n” dimension. It is clear from the characteristic amount vectors that the characteristic amount vectors of images belonging to different attributes (classes) are linearly independent from one another.

After Step S4, the display method determining unit 103D projects the characteristic amount vectors generated at Step S4 onto the viewing plane and determines the display position of the thumbnail image of each image. The display method determining unit 103D also determines a display size suitable for the display of each thumbnail image, based on the determined display positions (Step S5).

The SOM can be used as a method of performing dimensional compression of a high-dimension characteristic amount vector generated at Step S4 and determining the position on the viewing plane. In this case, when the number of dimensions of a portion at which the attribute is quantified (the same as “class number” in the example above) is high, the display method determining unit 103D determines the display position of each image such that the images having the same attributes are disposed near one another. Furthermore, the display method determining unit 103D determines the display position of each image belonging to the same attribute in adherence to a degree of similarity between image characteristics. Regarding the degree of similarity between the image characteristics, the display method determining unit 103D, for example, calculates a dispersion of the image characteristic amount of each image. The degree of similarity is determined to be higher as the dispersion becomes smaller. The display method determining unit 103D determines the display position of each image such that the images are closer as the degree of similarity becomes higher.

After Step S5, the display image generating unit 103E generates the thumbnail images in the display sizes determined by the display method determining unit 103D. The display image generating unit 103E generates a list of thumbnail images in which each thumbnail image is disposed at the display position determined by the display method determining unit 103D (Step S6). Then, the display image generating unit 103E judges whether all images have been processed (Step S7). When a judgment result is YES, the display image generating unit 103E outputs the list of thumbnail images to the display unit 102 and completes the process (Step S8). When the judgment result at Step S7 is NO, the image processing apparatus 100 returns to Step S1 and processes a next image.

FIG. 5 is a schematic diagram of an example of the list of thumbnail images when ordinary document images are to be displayed. Each thumbnail image is classified by the attribute of the original image and displayed. The thumbnail images belonging to a same attribute are arranged in accordance to the degree of similarity between the image characteristics. In FIG. 5, for example, thumbnail SM1_1 to thumbnail SM1_7 of images belonging to the attribute “diagram” are each displayed near an attribute name ZM1 that is “diagram”. The thumbnail SM1_1 to thumbnail SM1_7 are disposed such that the degree of similarity is higher between the original image of the thumbnail SM1_1 and the original image of the thumbnail SM1_2, and between the original image of the thumbnail SM1_1 and the original image of the thumbnail SM1_7.

As the method of displaying the list of thumbnail images, simple minified images can be displayed. Alternatively, the display size of a group of images belonging to an attribute of interest (class of interest) can be enlarged. Alternatively, the group of images can be displayed in high resolution or highlighted. Alternatively, only images belonging to the class of interest can be displayed. Moreover, a method disclosed in, for example, Japanese Patent Application Laid-open No. 2006-303707 can be used to determine the display size of the thumbnail image based on the image characteristic amount. In the method, a detailed image may be generated of which the content is difficult to recognize without high magnification. In this case as well, the method allows a size suitable for allowing the content to be recognizable to be determined as the display size of the thumbnail image.

As described above, the image to be displayed is classified by attribute. Moreover, a list of thumbnail images can be generated in which images having similar image characteristics, among the images belonging to the same attribute, are arranged near one another. An image map such as this is advantageous when a user retrieves a target image from a large number of images using attributes and image characteristics as a search key. The image map is advantageous, for example, when the user narrows down the area of interest based on a rough classification of the attribute and zooms in on the narrowed area. In this case, after the user zooms in and narrows down the area of interest, the user can easily predict the display position of the thumbnail image of the target image in the list of thumbnail images by recalling a visual memory, such as color and texture of the target image. Because an arrangement concept of the images in the image map is easily communicated to the user, the user can easily narrow down the area of interest. Therefore, the user can efficiently retrieve the target image.

The user can also easily visually confirm the classification concept of the list of thumbnail images as a result of the images being classified using the attribute indicating an overview of the image.

Because the characteristic amount vectors of images belonging to different attributes are linearly independent, a favorable characteristic amount vector can be generated even when no association, such as dependency, is present between each attribute. When there is no dependency between each attribute, the arrangement of each class when the list of thumbnail images is displayed is determined by an image characteristic amount other than the attribute. In other words, the thumbnail images of images with visually similar properties are disposed adjacent to one another for each attribute. An arrangement can be provided that is suitable for allowing the user to retrieve an image based on visual information.

Because the characteristic amount vector is calculated by a combination of the quantified and vectored attribute information and the vectored image characteristic amount, an arrangement of thumbnail images reflecting the attribute information and the degree of similarity between the image characteristics can be easily actualized by dimensional compression being performed from a high dimension, such as a SOM, to a viewing plane.

According to the first embodiment, the display image is a two-dimensional still image. However, the image to be displayed is not limited thereto. The image can be a three-dimensional (3D) image or a moving image. When the image is the 3D image, in a manner similar to that described above, the image processing apparatus 100 uses a center of mass of each object and an image size of the original image to determine display positions of thumbnail images including each object. The image is then disposed three-dimensionally in a display area. When the image is the moving image, the image processing apparatus 100 holds coordinate values including a time axis (fx, fy, t). When the list of thumbnail images is displayed, video images can be displayed at positions similar to those at which the two-dimensional images are displayed and reproduced. Alternatively, the video images can be displayed three-dimensionally.

Next, an image processing apparatus 100 according to a second embodiment of the present invention will be described. Sections that are the same as those according to the first embodiment are given the same reference numbers. Explanations thereof are omitted.

According to the second embodiment, attributes of an image to be displayed have a hierarchical structure. In this case, the attribute identifying unit 103A of the image processing apparatus 100 reads images to be displayed from the storing unit 104, analyzes the images, identifies an attribute at each level for each image, and classifies each image by the attribute at each level. The characteristic amount vector generating unit 103C generates a characteristic amount vector for each image classified by the attribute at each level, based on the attribute information and the image characteristic quantities stored in each image folder F1 to image folder FN in the storing unit 104. The display method determining unit 103D projects the characteristic amount vectors generated by the characteristic amount vector generating unit 103C onto the viewing plane and determines the display positions of the thumbnail images. An association is not set between each attribute (class) by which the images are classified. The display image generating unit 103E generates the list of thumbnail images for each level and outputs the list of thumbnail images to the display unit 102 accordingly.

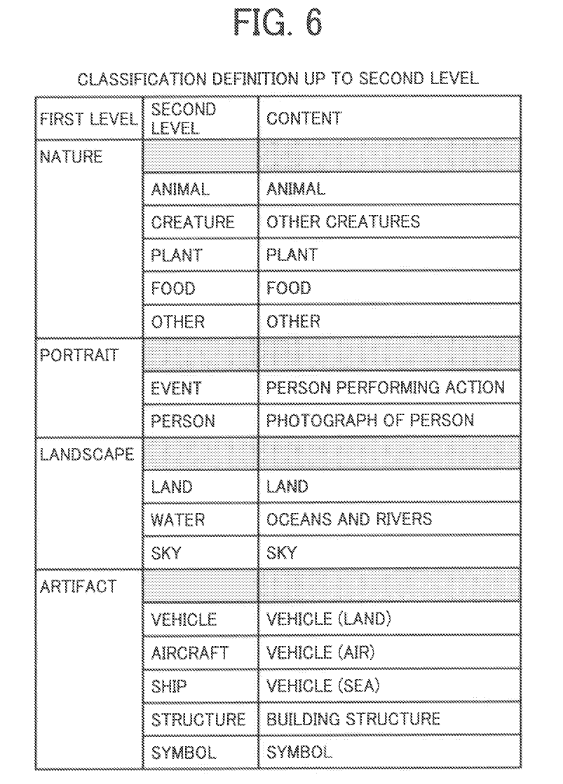

FIG. 6 is a schematic diagram of an example of attributes of a photographic image of which the attributes are set up to the second level. As shown in FIG. 6, the first level is classified into four classes: “portrait”, “nature”, “artifact”, and “landscape”. Second level classifications are set for each class.

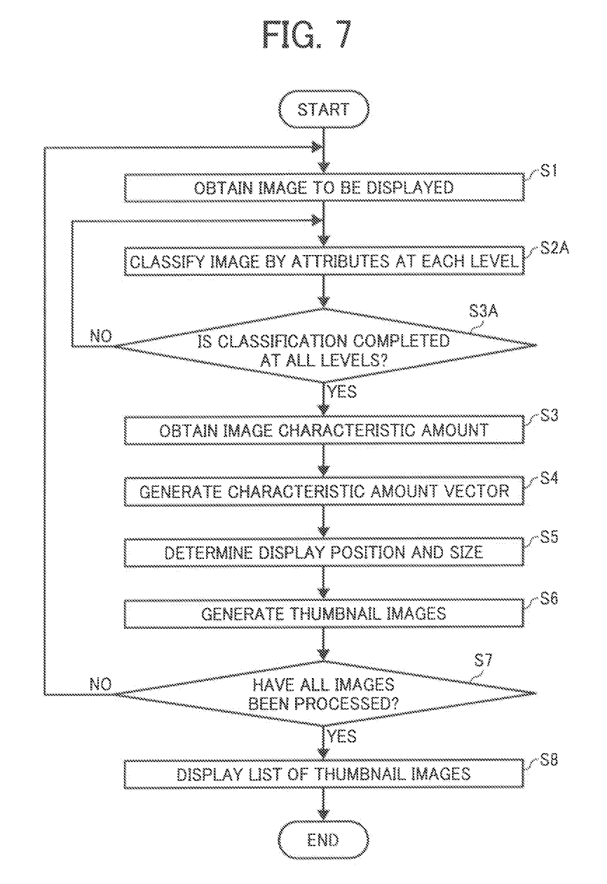

A process for displaying the thumbnail images performed by the image processing apparatus 100 according to the second embodiment will be described with reference to FIG. 7. The attribute identifying unit 103A of the image processing apparatus 100 reads each image to be displayed from the storing unit 104 (Step S1). The attribute identifying unit 103A analyzes each image, identifies the attribute at each level for each image, and classifies each image by the attributes at each level (Step S2A). Then, the attribute identifying unit 103A associates the attribute information respectively indicating the identified attribute at each level with the image and stores the attribute information in the above image folder F1 to image folder FN. The attribute identifying unit 103A performs the process at Step S2A for all levels. Then, when the classification is completed for all levels (Step S3A), the image processing apparatus 100 proceeds to Step S3. Step S3 is the same as that according to the first embodiment. Next, at Step S4A, the characteristic amount vector generating unit 103C generates the characteristic amount vector for each image classified by the attribute at each level based on the attribute information stored in each image folder F1 to image folder FN and the image characteristic amount obtained at Step S3.

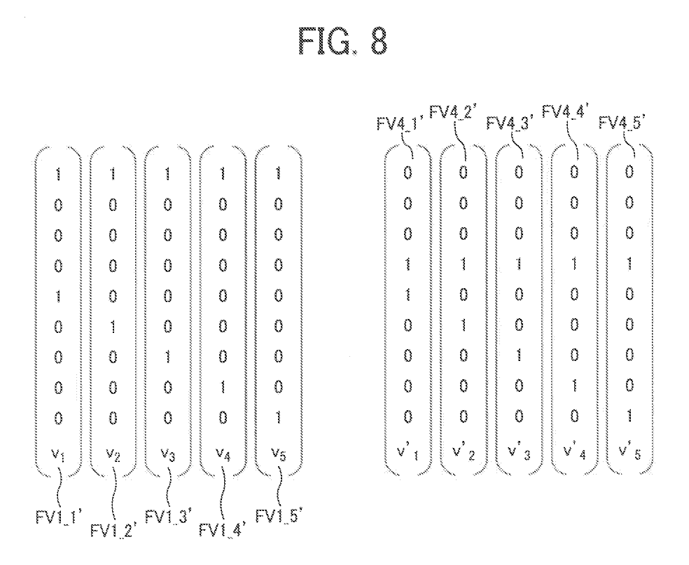

At Step S4, the characteristic amount vector generating unit 103C generates the characteristic amount vector by combining the quantified and vectored attribute indicated by the attribute information and the vectored image characteristic amount. FIG. 8 is a schematic diagram of an example of the characteristic amount vectors. In the characteristic amount vectors in FIG. 8, the images belonging to different attributes are linearly independent from one another. According to the second embodiment, because an association is not set between each attribute (class), in the characteristic amount vectors in FIG. 8, the images belonging to different attributes are linearly independent from one another. In FIG. 8, the characteristic amount vectors of when a class number at the first level is “4” and a maximum value of a class number at the second level is “5” in adherence to the hierarchical structure shown in FIG. 6 are indicated. Characteristic amount vector FV1_1′ to characteristic amount vector FV1_5′ in FIG. 8 indicate characteristic amount vectors of images classified as class 1 at the first level (for example, “nature” in FIG. 6). Characteristic amount vector FV4_1′ to characteristic amount vector FV4_5′ in FIG. 8 indicate characteristic amount vectors of image data classified as class 4 at the first level (for example, “artifact” in FIG. 6).

In particular, a number of dimensions expressed by quantification of a classification result at each level is “number of dimensions=class number”. The number of dimensions is combined with a number of dimensions “n” of a characteristic amount vector, and a characteristic amount vector of the “n+ (class number at first level)+(maximum value of class number at second level)” dimensions is used. When, in general, a depth of a level is k and a maximum value of a number of clusters at each level is “mk”, the number of dimensions of the characteristic amount vector after composite is “(m1+m2+ . . . mk)” dimension. The highest class number at the first level is “4”. Therefore, the fourth dimension in the characteristic amount vector is used to quantify the classification of the first level. For example, when an image belongs to class 1, the value of the first dimension is “1”. When an image belongs to the fourth dimension, the value of the fourth dimension is “1”. The fifth dimension to ninth dimension of the characteristic amount vector are used to quantify the classification of the second level. For example, when an image belongs to class 1 at the second level, the value of the fifth dimension is “1”. When an image belongs to class 5 at the second level, the value of the ninth dimension is “1”. It should be noted in particular that even in the lowest order level of the characteristic amount vector, the characteristic amount vectors of images belonging to different classes are linearly independent from each other.

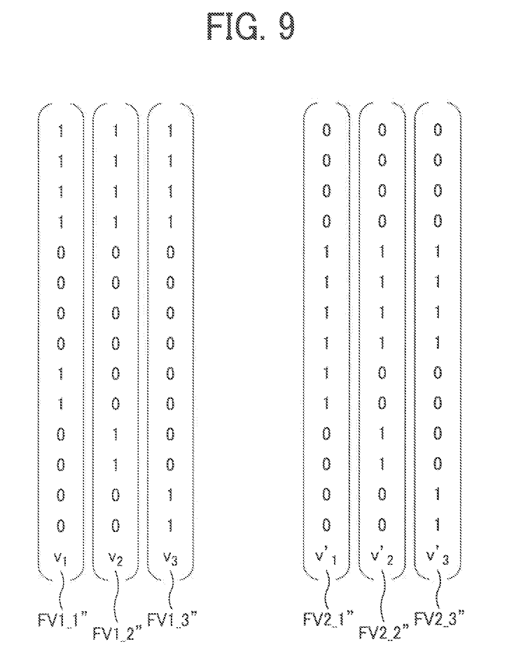

Furthermore, the characteristic amount vector can be generated with a weight set for each level. FIG. 9 is an example of characteristic amount vectors such as this. In the characteristic amount vectors in FIG. 9, the images belonging to different classes are linearly independent from one another. Regarding attributes having the hierarchical structure, the characteristic amount vector is generated with the weight being added. Characteristic amount vector FV_1″ to characteristic amount vector FV1_3″ indicate characteristic amount vectors of images classified as class 1 at the first level (for example, “nature” in FIG. 6). Characteristic amount vector FV2_1″ to characteristic amount vector FV2_5″ in FIG. 8 indicate characteristic amount vectors of image data classified as class 2 at the first level (for example, “portrait” in FIG. 6).

In the example, the class number of the first level is “2”. The class number of the second level is “3”. The weight of the first level is “4”. The weight of the second level is “2”. In the hierarchical structure shown in FIG. 6, the class number of the first level is “4”. The maximum value of the class number of the second level is “5”. In this case, the number of dimensions by which the classification result of each level is quantified is “cluster number×weight”. This is combined with the “n” number of dimensions of the characteristic amount vector, and the characteristic amount vector of a “n+(maximum value of cluster number of first level)×w1+(maximum value of cluster number of second level)×w2” dimensions is used. When, in general, a depth of a level is k, a maximum value of a cluster number in each level is “mk”, and a weight of each level is wk, the number of dimensions of the characteristic amount vector after composite is “(w1×m1+w2×m2+ . . . wk×mk)+n” dimensions. At this time, the weight specified at each level is set to establish a size relationship that is “w1<w2< . . .<wk”. Therefore, the classification of the high order level with a high weight has a significant effect on the arrangement of the thumbnail images. In these characteristic amount vectors as well, it is clear that the characteristic amount vectors of the images belonging to different classes are linearly independent from one another regarding the lowest order level as well.

After Step S4, the process is similar to that according to the first embodiment. At Step S8, the display image generating unit 103E first generates the list of thumbnail images arranged by the classification based on the attributes at the first level. The generated list of thumbnail images is outputted to the display unit 102. Then, based on an instruction entered by the user instructing image switch, the display image generating unit 103E generates the list of thumbnail images arranged by the classification based on the attributes at the second and subsequent levels. The generated list of thumbnail images is then outputted to the display unit 102.

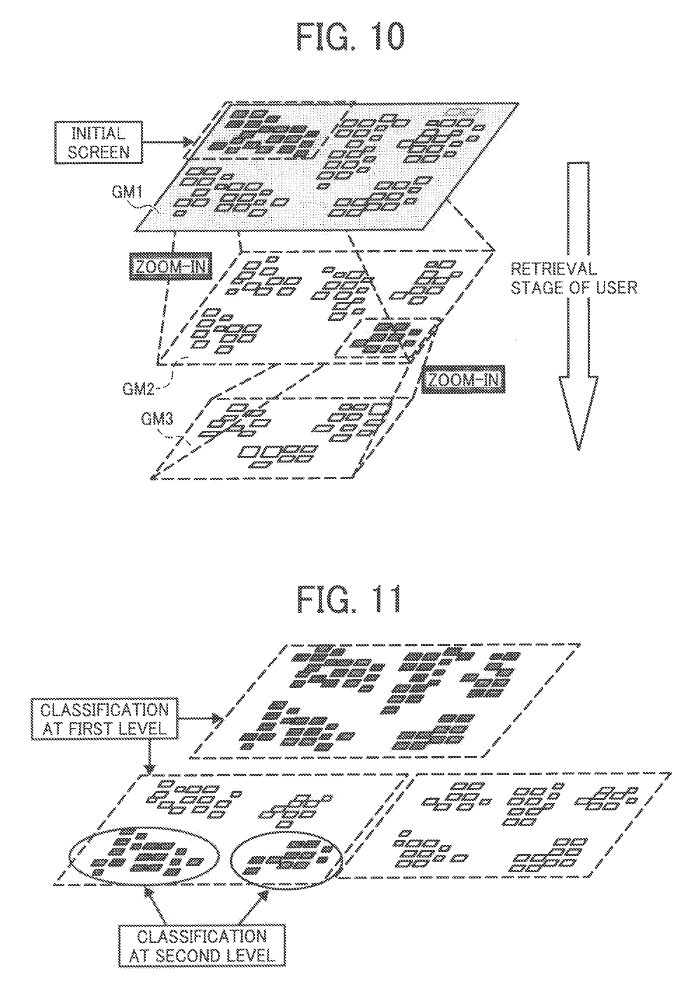

FIG. 10 is a conceptual diagram of when a list of thumbnail images of images set to attribute classification having a hierarchical structure reaching the second level is displayed. First, an initial screen GM1 is displayed in which the thumbnail images classified by the attribute at each level are disposed. Then, as a retrieval stage progresses by the user narrowing down a search area while viewing the image map displayed on the screen, the screen switches to a display screen GM2 and a display screen GM3. On the display screen GM 2, a thumbnail image group arranged by classification based on the attribute of a low order level is enlarged. On the display screen GM3, a thumbnail image group classified by the same attributes is enlarged. FIG. 11 is a schematic diagram of an example of a list of thumbnail images on the initial screen GM1. In FIG. 11, the thumbnail images are displayed classified by the attribute at the first level and classified by the attribute at the second level.

According to the above configuration, the thumbnail images of the images to be displayed can be arranged to reflect the hierarchical structure of the attributes. For example, the thumbnail images of the images belonging to the same attributes at an Nth level are arranged in a group. In addition, the thumbnail images of the images belonging to the same attributes at an N+1th level that is lower than the Nth level can be disposed in a group and displayed. In other words, when the user retrieves an image in the above list of thumbnail images, each thumbnail image classified by the attribute at a high order level is displayed in a zoomed-out state (list display). Each thumbnail image classified by the attribute at the low order level is displayed in a zoomed-in state (partial display). Therefore, a retrieving and browsing method can be provided in which the retrieval stage and the number of level in the hierarchical structure of the attributes simultaneously progress. In terms of operations performed by the user, by the user repeatedly determining an area to be searched and performing a zoom-in operation, an efficient retrieval taking advantage of the hierarchical classification structure of the image can be performed.

To generate the characteristic amount vector using every attribute at every level, an image map can be provided that reflects classification results of the attributes at all levels.

The image characteristic used as the image characteristic amount when generating the characteristic amount vector can be determined based on the attribute of the image to be displayed. For example, attribute correspondence information indicating a correspondence between the attribute and a type of image characteristic can be stored in the storing unit 104 in advance. Alternatively, the correspondence can be set accordingly depending on an instruction entered by the user. Then, at Step S4, the characteristic amount vector generating unit 103C determines the type of image characteristic corresponding with the attribute of the image to be processed and generates the characteristic amount vector using the image characteristic amount indicating the type of image characteristic. For example, in the upper level, the image characteristic advantageous for recognizing an overview of the image, such as an overall color, can be used. As the level deepens, detailed image characteristics can be used, such as edge distribution information and composition information.

In a configuration such as this, image groups belonging to each attribute can be arranged based on the image characteristic suitable for displaying the image groups. For example, when an image group belonging to a certain attribute only includes images having a similar texture, the user can more easily recognize the feature of each image when the images are arranges using an image characteristic other than texture. Therefore, an image map suited to the user can be provided.

In an image map such as this, it is preferable that the classification is visible regarding thumbnail images with a high reduction rate as the level of the attribute becomes higher. Therefore, rather than attributes such as those shown in FIG. 6 being used, for example, attributes can be used that take into consideration visual recognition of the thumbnail images depending on the level. As described above, thumbnail images classified by the attribute at a high order level are displayed in the zoomed-out state (list display). Thumbnail images classified by the attribute at the low order level are displayed in the zoomed-in state (partial display). It should be noted that, because a large number of thumbnail images are required to be displayed in the zoomed-out state, the display size of each thumbnail image is most likely small. The display size of each thumbnail image can increase as the zoom-in operation is repeated. Taking into consideration the display size of the thumbnail images and ease of determining classification at each display stage, the user may not recognize the classification concept when, for example, the thumbnail images of images classified based on “an object included in the image” are displayed in a high order level. Therefore, at a high order level, classification that can be visually determined even under high-power reduction, such as “classification by overall color” and “classification by texture”, is effective.

For example, in FIG. 10, all thumbnail images classified by the attribute at each level are displayed on the initial screen GM1. Therefore, a large number of thumbnail images reduced at a high-power are arranged and displayed. On a screen such as this, each thumbnail image is arranged such as to be grouped by class (attribute) and displayed. However, it is preferable that relationships between classes are classified by a visually recognizable feature to allow the user to determined the class (attribute) to which the target image may belong. “Color”, for example, can be considered as the visually recognizable feature of the thumbnail images. Therefore, for example, “color” is used as the feature for classifying the attribute at the first level. Classification of the attribute can be defined in advance, such as reddish images belonging to one class, bluish images belonging to another class, and greenish images belonging to still another class. As a result of the classification, the user can determine the class to which the target image belongs if the user remembers an overview of the target image, even when the list of thumbnail images is displayed. On the other hand, “composition” can be considered as a feature that is difficult to visually recognize in the thumbnail images. Features such as this can be used to classify the attribute at a low order level. In other words, for example, the image characteristic “color” is used as a classification indicator at the first level. The image characteristic “composition” is used as the classification indicator at the second level. As a result, the user can clearly visually recognize the relationships between classes. In this case, the image processing apparatus 100 analyzes the images to be displayed and uses the image characteristic quantities to classify the images by the attribute at each level based on the image characteristics such as “color” and “composition”.

In a configuration such as this, when the user narrows down the area of interest using the retrieving and browsing method in which the retrieval stage and the number of levels in the hierarchical structure of the attributes simultaneously progress, an image map can be provided that allows the user to accurately and easily recognize the classification concept at each retrieval stage.

Next, an image processing apparatus 100 according to a third embodiment of the present invention will be described. Sections that are the same as those according to the first embodiment or the second embodiment are given the same reference numbers. Explanations thereof are omitted.

According to the third embodiment, when, in the image processing apparatus according to the second embodiment, an association is set in advance between each attribute by which images are classified will be described. For example, the association is set such that a degree of association (association level) rises as the association between attributes strengthens. The association level decreases as the association between the attributes weakens. Attribute level information indicating the association level is stored in the storing unit 104. The characteristic amount vector generating unit 103C generates a characteristic amount vector by further using the association level between the attributes indicated by the association level information stored in the storing unit 104. Then, the display method determining unit 103D determines a display position of each thumbnail image using characteristic amount vectors generated in this manner.

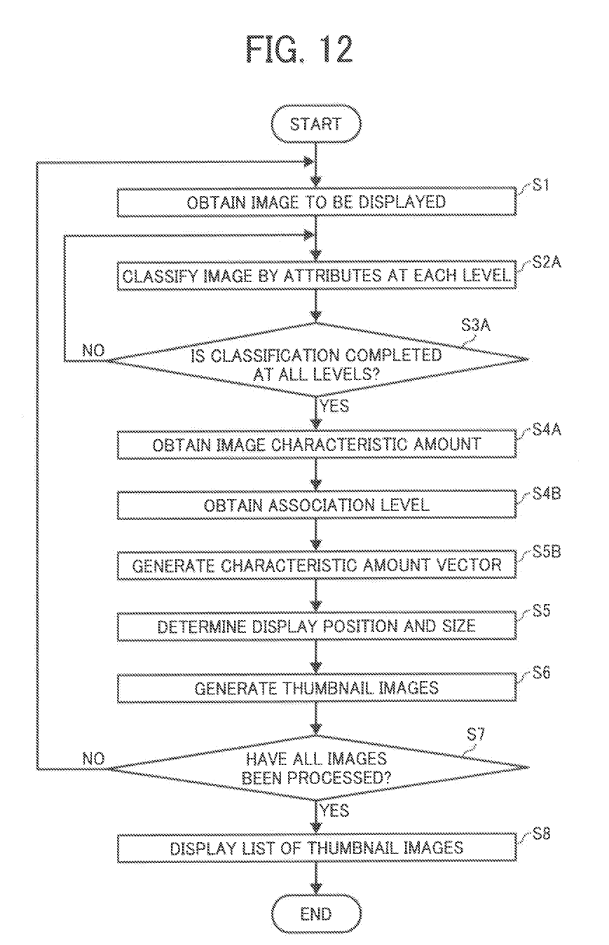

A process for displaying thumbnail images performed by the image processing apparatus 100 according to the third embodiment will be described with reference to FIG. 12. Step S1 to Step S4A are similar to those according to the second embodiment. At Step S4B, the characteristic amount vector generating unit 103C references the association level information stored in the storing unit 104 for each image classified by the attribute at each level and obtains the association level between the attribute of each image and another attribute at each level. The characteristic amount vector generating unit 103C then generates a characteristic amount vector for each image based on the obtained association level, and the attribute information and the image characteristic amount stored in each image folder F1 to image folder FN of the storing unit 104 (Step S5B).

At this time, the characteristic amount vector generating unit 103C generates, for example, characteristic amount vectors of two images belonging to a same attribute at a high order level or characteristic amount vectors of two images belonging to arbitrary attributes at the lowest order level such that an average value (or minimum value) of a distance between characteristic amount vectors when the association between the attributes is strong is smaller than an average value (or minimum value) of a distance between characteristic amount vectors when the association between the attributes is weak. The characteristic amount vector is generated by the feature vector given as an example according to the second embodiment being further combined with a vectored association level of each attribute at each level. The association level is vectored by the number of dimensions being adjusted based on the association level.

The process subsequent to Step S5 is similar to that according to the first embodiment or the second embodiment.

As described above, when there is an association between the attributes, the characteristic amount vector is generated based on the association. The thumbnail images can be arranged such that thumbnail images belonging to attributes having a strong association are near one another. The thumbnail image display can reflect the association between attributes. Therefore, the user can more quickly and more efficiently find the attribute to which the target image belongs by recognizing properties of a plurality of attributes near the target image. The user can quickly recognize the area of interest.

Next, an image processing apparatus 100 according to a fourth embodiment of the present invention will be described. Sections that are the same as those according to the first embodiment, the second embodiment, or the third embodiment are given the same reference numbers. Explanations thereof are omitted.

According to the fourth embodiment, the image processing apparatus 100 is described in which a single image to be retrieved includes a plurality of pages (page images) configuring a single document. In this case, the image processing apparatus 100 classifies each image in document units based on an attribute of a representative page image among the page images and generates a characteristic amount vector using the attribute per document and an image characteristic amount.

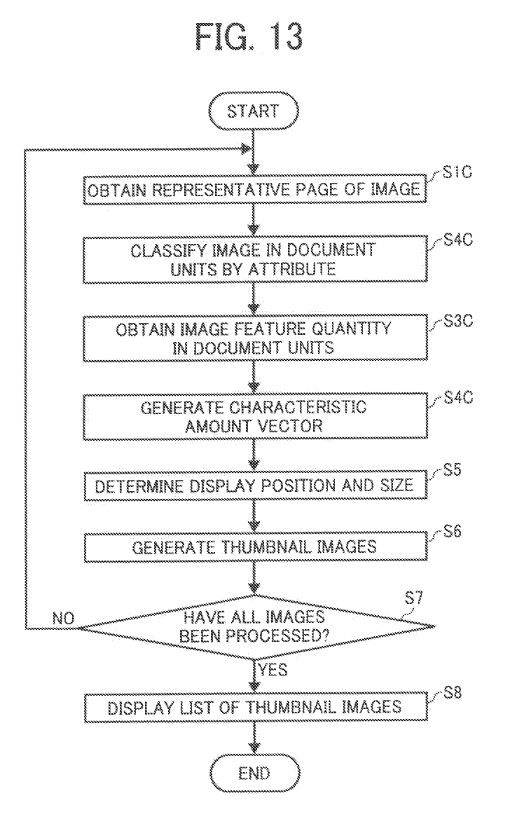

A process for displaying thumbnail images performed by the image processing apparatus 100 according to the fourth embodiment will be described with reference to FIG. 13. The attribute identifying unit 103A reads each image to be displayed from the storing unit 104 and obtains a representative page image of each image (Step S1C). A method of determining the representative page image to be obtained from among a plurality of page images is not particularly limited. For example, a page image of a page number set in advance (for example, the first page) can be obtained as the representative image. Alternatively, a page number of the representative page image can be set by the user entering a setting. Representative page information indicating the page number can be associated with each image. The attribute identifying unit 103A can obtain the representative page image by referencing the representative page information.

The attribute identifying unit 103A then analyzes the obtained representative page image of each image and identifies the attribute of each image. The attribute identifying unit 103A classifies each image in document units by the attribute of each representative page image (Step S2C). Next, the image characteristic obtaining unit 103B obtains an image characteristic amount of each image in document units (Step S3C). The characteristic amount vector generating unit 103C then generates a characteristic amount vector for each image in document units, based on the attribute to which the image is classified at Step S2C and the image characteristic amount obtained at Step S3C (Step S4C). The process subsequent to Step 5 is similar to that according to the first embodiment.

As a result of a configuration such as that described above, the images to be displayed can be arranged in document units. Therefore, an image map can be provided that is suitable for when the user performs a search relying on a recollection of an overall document.

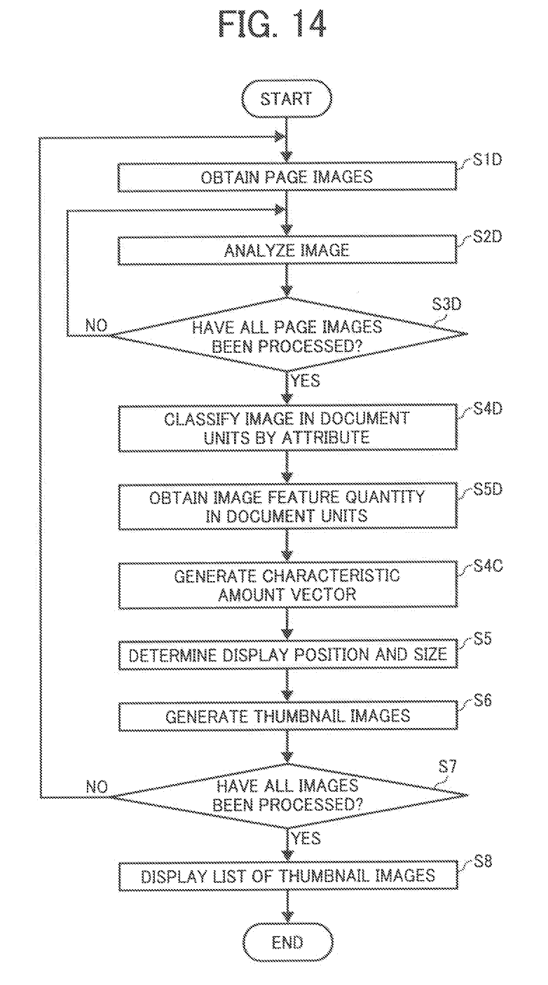

According to the fourth embodiment, the attribute is identified by the representative page being analyzed. However, the attribute can be identified in document units based on an analysis of all page images and a result of the analysis. FIG. 14 is a flowchart of a process for displaying the thumbnail images performed by the image processing apparatus 100 when the analysis is performed on all page images. The attribute identifying unit 103A sequentially obtains page images starting from the first page for each image to be displayed (Step S1D). The attribute identifying unit 103A then analyzes each image (Step S2D). The attribute identifying unit 103A performs the process at Step S2D for all levels. Then, when all page images have been analyzed (Yes, at Step S3D), the attribute identifying unit 103A classifies each image in document units by the attribute based on the result of the analysis at Step S2D (Step S4D). The image characteristic obtaining unit 103B obtains an image characteristic amount in document units (Step S5D). The characteristic amount vector generating unit 103C then generates a characteristic amount vector in document units based on the obtained image characteristic amount (Step S4C). The process subsequent to Step 5 is similar to that according to the first embodiment.

As a result of a configuration such as that described above, the images to be displayed can be arranged in document units depending on the attributes and the image characteristics. Therefore, an image map can be provided that is suitable for when the user performs a search based on overall image characteristics.

The present invention is not limited to the above embodiments. Various modifications to constituent elements can be made at an application stage without departing from the spirit of the invention. Various inventions can also be achieved by appropriate combinations of a plurality of constituent elements disclosed according to the embodiments. For example, a number of constituent elements can be eliminated from all constituent elements described according to the embodiments. Moreover, constituent elements according to different embodiments can be appropriately combined. Various modifications such as those described below can also be made.

According to each of the above embodiments, various programs run by the image processing apparatus 100 can be stored on a computer connected to a network, such as the Internet. The various programs can be provided through downloading over the network. The various programs can also be provided by being recorded on a recording medium that can be read by the computer, such as a compact disc read-only memory (CD-ROM), a flexible disk (FD), a compact disc recordable (CD-R), or a digital versatile disk (DVD), as a file in an installable format or an executable format.

According to each of the above embodiments, the images to be displayed are obtained by the images being read from the storing unit 104. However, the image processing apparatus 100 can obtain the images from a computer connected to a network, such as the Internet. Alternatively, the image processing apparatus 100 can obtain images stored on a recording medium that can be read by the computer, such as a CD-ROM, a FD, a CD-R, or a DVD, as a file in an installable format or an executable format.

The image processing apparatus according to each of the above embodiments can be a computer, a copier, a printer, a facsimile machine, or a multifunction product providing a copy function, a print function, and a facsimile function in combination.

According to each of the above embodiments, the image processing apparatus 100 includes the input unit 101 and the display unit 102. However, the image processing apparatus 100 is not required to include the input unit 101 and the display unit 102. The image processing apparatus 100 can be externally connected to an input unit and a display unit by wired or wireless connection.

As described above, according to one aspect of the present invention, image retrieval using an image map can be efficiently performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for processing an image, comprising:
a classifying unit that analyzes a plurality of images to be displayed and classifies the images by attributes;
an obtaining unit that obtains image characteristic information indicating an image characteristic from each of classified images;
a first generating unit that generates a characteristic amount vector for each of the images using the attributes and the image characteristic;
a determining unit that determines display positions of thumbnail images of the images such that thumbnail images of same attribute are displayed close to each other and thumbnail images of higher degree of similarity are displayed closer to each other based on the characteristic amount vector generated by the first generating unit; and
a second generating unit that generates the thumbnail images and a list of thumbnail images in which the thumbnail images are arranged in the display positions determined by the determining unit.

2. The apparatus according to claim 1, wherein the attributes include an overview of an image.

3. The apparatus according to claim 1, wherein the classifying unit analyzes the images and classifies the images by at least one of preset attributes.

4. The apparatus according to claim 1, wherein the first generating unit generates the characteristic amount vector by combining a vectored attribute and a vectored image characteristic.

5. The apparatus according to claim 1, wherein
a relevance is set in advance between the attributes, and
the first generating unit generates the characteristic amount vector based on the relevance between an attribute of a classified image and other attribute.

6. The apparatus according to claim 1, wherein
the attributes have a hierarchical structure, and
the classifying unit classifies the images by an attribute at each level.

7. The apparatus according to claim 6, wherein the attribute is defined in advance based on the image characteristic such that visual recognizability becomes higher in a thumbnail image having a higher reduction rate as a hierarchical level of the attribute becomes higher.

8. The apparatus according to claim 7, wherein
a relevance is set in advance between the attributes, and
the first generating unit generates characteristic amount vectors of two images belonging to same attribute at a higher hierarchical level or characteristic amount vectors of two images belonging to arbitrary attributes at a highest hierarchical level such that an average value of a distance between characteristic amount vectors when the relevance between the attributes is strong is smaller than an average value of a distance between characteristic amount vectors when the relevance between the attributes is weak.

9. The apparatus according to claim 7, wherein the first generating unit generates characteristic amount vectors of two images belonging to same attribute at a higher hierarchical level or characteristic amount vectors of two images belonging to arbitrary attributes at a highest hierarchical level such that a minimum value of a distance between characteristic amount vectors when the relevance between the attributes is strong is smaller than a minimum value of a distance between characteristic amount vectors when the relevance between the attributes is weak.

10. The apparatus according to claim 6, wherein the first generating unit generates the characteristic amount vector by combining a vectored attribute at each hierarchical level and a vectored image characteristic.

11. The apparatus according to claim 6, wherein the first generating unit generates the characteristic amount vector by adding a different weight for each hierarchical level to each vectored attribute at each hierarchical level.

12. The apparatus according to claim 1, wherein the first generating unit determines a type of image characteristic used to generate the characteristic amount vector based on the attribute, and generates the characteristic amount vector using the attribute and the image characteristic.

13. The apparatus according to claim 1, wherein when a single image includes a plurality of pages configuring a single document, the classifying unit classifies the image in units of documents by attributes.

14. The apparatus according to claim 1, wherein when a single image includes a plurality of pages configuring a single document, the obtaining unit obtains the image characteristic information of the image in units of document.

15. The apparatus according to claim 1, wherein the determining unit determines a display position of the thumbnail image in at least one of a one-dimensional space, a two-dimensional space, and a three-dimensional space.

16. The apparatus according to claim 1, further comprising a display unit that displays thereon the list of thumbnail images.

17. The apparatus according to claim 1, wherein the first generating unit generates the characteristic amount vector such that characteristic amount vectors of images classified into different attributes are linearly independent from each other.

18. A method of processing an image, comprising:
classifying including
analyzing a plurality of images to be displayed, and
classifying the images by attributes;
obtaining image characteristic information indicating an image characteristic from each of classified images;
first generating including generating a characteristic amount vector for each of the images using the attributes and the image characteristic;
determining display positions of thumbnail images of the images such that thumbnail images of same attribute are displayed close to each other and thumbnail images of higher degree of similarity are displayed closer to each other based on the characteristic amount vector generated at the first generating; and
second generating including generating the thumbnail images and a list of thumbnail images in which the thumbnail images are arranged in the display positions determined at the determining.
